(19) United States
(12) Patent Application Publication
(10) Pub. No.: US 2018/0352319 A1
(43) Pub. Date: Dec. 6, 2018

(54) CONTROL AND CHARGING MECHANISM FOR WIRELESS EARBUDS

(71) Applicant: Ashley Chloe, Inc., San Mateo, CA (US)

(72) Inventors: Anson Liang, Foster City, CA (US); Angela Pan, Foster City, CA (US); Guanxin Xing, Shenzhen (CN); David Northway, San Mateo, CA (US); Brian Knauss, San Mateo, CA (US)

(21) Appl. No.: 15/994,844

(22) Filed: May 31, 2018

Related U.S. Application Data
(63) Continuation-in-part of application No. 15/806,781, filed on Nov. 8, 2017.
(60) Provisional application No. 62/513,321, filed on May 31, 2017.
(60) Provisional application No. 62/513,325, filed on May 31, 2017.
(60) Provisional application No. 62/513,329, filed on May 31, 2017.

(51) Int. Cl. H04R 1/10

(52) U.S. Cl. CPC H04R 1/1025; H04R 2420/07; H04R 1/1016

(57) ABSTRACT

A wireless earbud includes a cylindrical body with an exterior end and a front speaker chamber located at an end opposite the exterior end. The front speaker chamber includes a tip that is substantially planar and a plurality of charging points located at the tip. An ear cushion/cap fits over and substantially surrounds the front speaker chamber.

### CROSS-REFERENCE TO RELATED APPLICATION(S)

This application is a continuation-in-part of the co-pending U.S. patent application Ser. No. 15/806,781, filed Nov. 8, 2017, entitled “MODULAR WIRELESS EARBUDS,” which is also hereby incorporated by reference in its entirety for all purposes. Further, this application claims priority under 35 U.S.C. § 119(e) of the U.S. Provisional Patent Application Ser. No. 62/513,321, filed May 31, 2017 and titled, “A CONDUCTIVE CHARGING MECHANISM FOR WIRELESS EARBUDS,” U.S. Provisional Patent Application Ser. No. 62/513,325, filed May 31, 2017 and titled, “A KNOB MECHANISM ON WIRELESS EARBUDS FOR CONTROLS,” and U.S. Provisional Patent Application Ser. No. 62/513,329, filed May 31, 2017 and titled, “A METHOD OF ENABLING WIRELESS CHARGING OF A WIRELESS EARBUD,” which are also all hereby incorporated by reference in their entirety for all purposes.

### FIELD OF INVENTION

The present invention generally relates to the field of wireless audio playback equipment. More specifically, the present invention relates to a control and charging mechanism for wireless earbuds.

### BACKGROUND OF THE INVENTION

Wireless earbuds are becoming increasingly popular. Unlike their wired counterparts, wireless earbuds need to be periodically charged for use. Charging touch points are around bodies of traditional wireless earbuds and, as such, the charging surfaces on these traditional wireless earbuds have a greater chance of being damaged.

### SUMMARY OF THE INVENTION

In an aspect, the present invention is directed to a wireless earbud that is able to be charged via a tip of a front speaker chamber of the wireless earbud. Charging touch points are part of the tip of the front speaker chamber. The tip of the front speaker chamber is made of metal to enable electrical conductivity. The tip of the front speaker chamber is divided into at least two parts to provide a minimum of two touch points for charging. In some embodiments, the tip of the front speaker chamber is divided into two parts, A and B, to provide two touch points for charging.

To charge the earbud, the earbud is placed in a charger. The tip of the front speaker chamber is coupled with charging pins in the charger. The charger charges the earbud via the electrical coupling with the tip of the front speaker chamber of the earbud.

A feature, which is able to be provided by either the earbud or the charger, detects the polarization of the current. Based on the detection, the charging reception is adjusted to fit the correct polarization of the current such that the earbud is able to be coupled with the charger in any direction (e.g., no matter how the A and B parts of the tip of the front speaker chamber are coupled with the charging pins of the charger) and be able to charge correctly with the correct polarization of the current.

In another aspect, the present invention is directed to a method of enabling wireless charging of a wireless earbud. During charging, the wireless earbud is electrically coupled with a charger via a metal-to-metal coupling between the earbud and the charger. In some embodiments, the charger has a receptacle end having a receptacle that is sized and adapted to receive the wireless earbud. Inside the receptacle are charging pins that are configured to couple with charging pins of the wireless earbud.

The charger has a battery embedded within it. Alternatively, the charger does not have an internal battery. However, the charger has electronic components to receive wireless charging, which charges the earbud when it is electrically coupled with the charger. The charger is able to come in many different form factors or designs.

In yet another aspect, the present invention is directed to a wireless earbud that has a control interface on the wireless earbud. The control interface enables rich control functionalities on the wireless earbud with limited physical space. The knob interface includes a knob control mechanism. The knob control mechanism is a part of the body of the wireless earbud. The knob control mechanism is able to be located at an external end of the wireless earbud or at a middle part of the wireless earbud. The knob control mechanism is able to be turned left and/or right continuously. In addition, the knob control mechanism is able to be pushed down if the knob control mechanism is located at the external end of the wireless earbud.

In an aspect, a wireless earbud comprises a cylindrical body having a body capable of fitting snugly within an ear of a user, an exterior end, and a front speaker chamber located at an end opposite the exterior end, wherein the front speaker chamber includes a tip that is substantially planar and comprises one or more charging points.

In some embodiments, the one or more charging points comprise a metal surface. In other embodiments, the one or more charging points comprise at least two charging surfaces electrically separated by at least two gaps. In some other embodiments, the two charging surfaces with the two gaps form an annulus. In some embodiments, the exterior end comprises a control unit. In other embodiments, the control unit comprises a rotational controlling member. In some other embodiments, the control unit comprises a push button. In some embodiments, the push button is surrounded by the rotational controlling member.

In another aspect, a method of enabling wireless charging of a wireless earbud comprises obtaining a charger, wherein the charger includes at least one receptacle end that includes a receptacle and charging pins, obtaining a wireless earbud that includes an exterior end and a front speaker chamber located at an end opposite the exterior end, wherein the front speaker chamber includes a tip that is substantially planar and a plurality of charging points located at the tip, and inserting the tip of the front speaker chamber of the wireless earbud into the at least one receptacle such that a metal-to-metal coupling between the earbud and the charger is established.

In some embodiments, the charger and two of the wireless earbuds form a pill shape structure. In other embodiments, the charger is coupled with a power source using two power receiving members on the charger. In some other embodiments, each of the two power receiving members form a circle surrounding the charger. In some embodiments, the at least one receptacle comprises at least one charging pin.

In another aspect, a wireless earbud comprises a cylindrical body, a control interface located at an external end of the body, and a knob structure at the control interface having a rotating element and the depressing element, wherein the rotating element and the depressing element are able to be activated to control one or more of a plurality of functions.

In some embodiments, the depressing element is centered at the rotating element. In other embodiments, the depressing element is configured as a command confirming button. In some other embodiments, the rotating element is configured as a command of increasing or reducing volume output of the earbud. In some embodiments, the cylindrical body comprises a charging port at an internal end. In some other embodiments, the charging port comprises two charging surfaces. In other embodiments, the two charging surfaces are electrically isolated by one or more gaps.

Other features and advantages of the present invention will become apparent after reviewing the detailed description of the embodiments set forth below.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates an exemplary earbud in accordance with some embodiments.

FIGS. 2A-2E illustrate different views of the earbud, with the ear cushion/cap removed, in accordance with some embodiments.

FIG. 3 illustrates an exemplary charger in accordance with some embodiments.

FIGS. 4A-4D illustrate an exemplary earbud in accordance with some embodiments.

FIG. 5 illustrates a method of recharging wireless earbuds in accordance with some embodiments.

FIGS. 6A-6C illustrate wireless earbuds with retention ring in accordance with some embodiments.

### DETAILED DESCRIPTION OF THE INVENTION

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

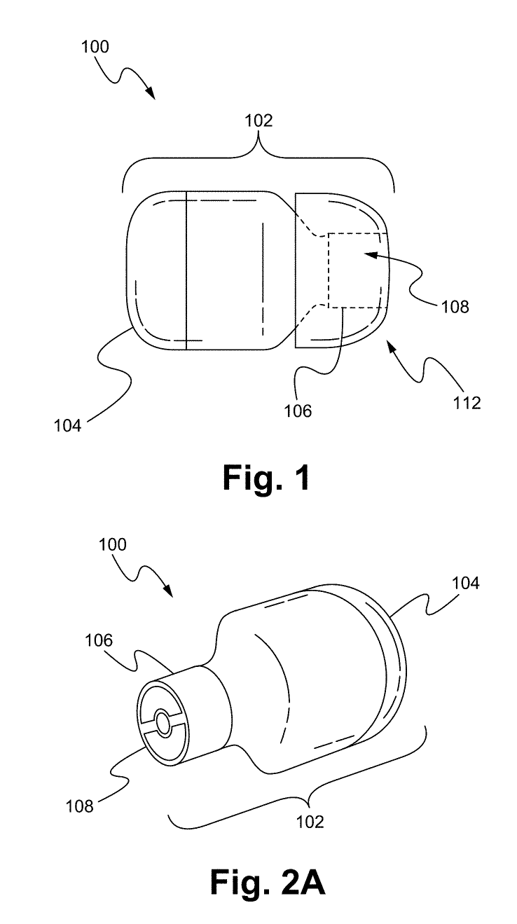

FIG. 1 illustrates an exemplary earbud 100 in accordance with some embodiments. The earbud 100 has a body 102. In some embodiments, at least a portion of the body 102 is ceramic, which provides durability and a comfortable surface temperature, and is lightweight and scratch-resistant. In some embodiments, the body 102 is made from other materials, such as plastic, rubber, and wood. The body 102 has an exterior end 104 and a front speaker chamber 106 located at an end opposite the exterior end 104, wherein the front speaker chamber 106 is configured to fit snuggly within a human user's ear and provide sounds therein.

In some embodiments, an ear cushion/cap 112 is sized and shaped to fit over and substantially surround the front speaker chamber 106, which has a smaller cross section than that of the exterior end 104. In some embodiments, the body 102 is cylindrical with the exterior end 104 being rounded. In some embodiments, the earbud 100 also includes a controller located at the exterior end 104. A person of ordinary skill in the art would appreciate that the body 102 is able to be shaped in various forms, as long as the earbuds 100 are able to serve the function of providing sounds from one or more electronic devices via wireless signals, such as WI-FI and bluetooth.

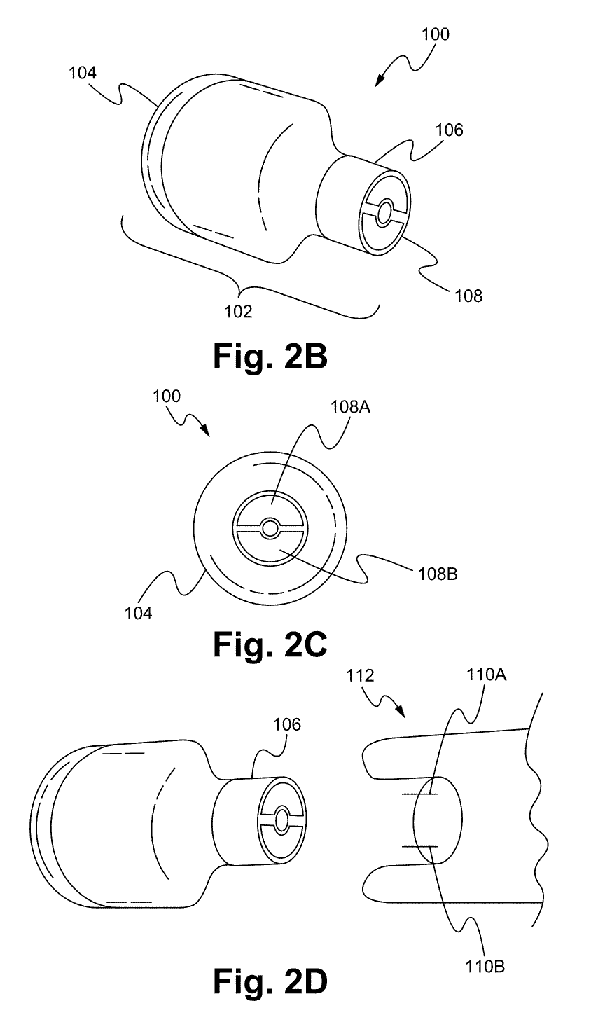

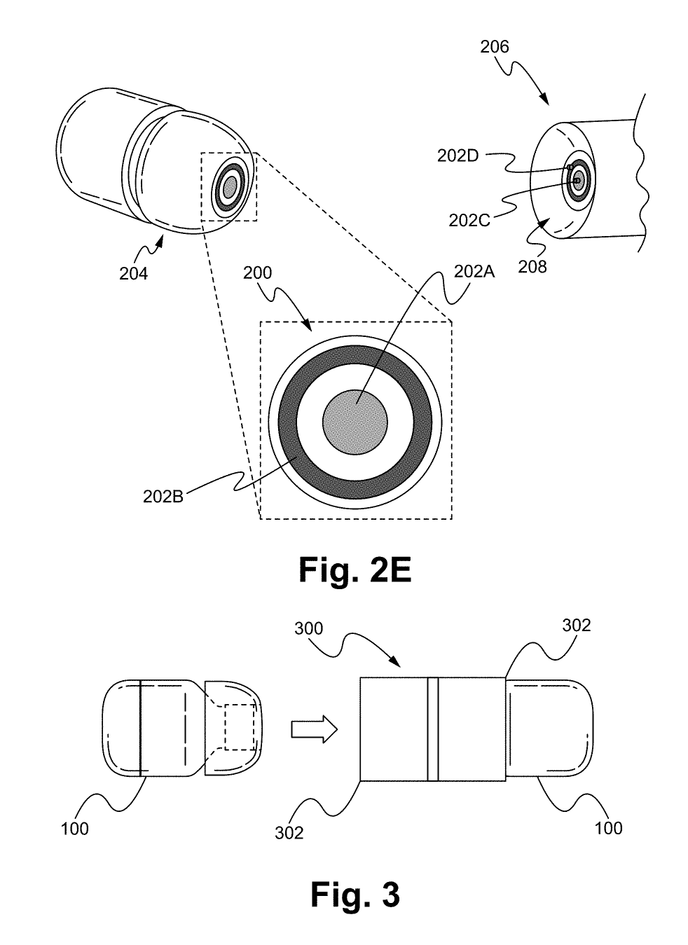

FIGS. 2A-2D illustrate different views of the earbud 100, with the ear cushion/cap 110 removed, in accordance with some embodiments. As illustrated in FIGS. 2A-2C, a tip 108 of the front speaker chamber 106 is substantially planar and is at the opposite end of the exterior end 104. In some other embodiments, the tip 108 contains an uneven surface (e.g., concave) or charging points. In some other embodiments, charging touch points 108A and 108B (FIG. 2C) of the earbuds 100 are located at the tip 108 of the front speaker chamber 106, which are electrically coupled with charging pins 110A and 110B of a charger (FIG. 2D) when the earbud 100 is in a charging state. The tip 108 of the front speaker chamber 106 is made of metal to enable electrical conductivity with the charging pins. In some embodiments, the tip 108 of the front speaker chamber 106 is divided into two parts, A-part 108A and B-part 108B, to provide two touch points for charging of different/opposite charging phases. It is contemplated that the tip 108 of the front speaker chamber 106 is able to be divided into more than two parts, with each providing a touch point for charging.

In the FIGS. 2A-2D, the tip 108 of the front speaker chamber 106 is shown as having two half circles for the two touch points for charging. A charging case 112 comprises two charging pints 110A and 110B, which are structured to electrically couple with the surfaces 108A and 108B, such that the electrical power in the charging case 112 (e.g., a contained battery) is able to be transmitted to the earbud 100. The above mentioned touch point pattern is only exemplary.

FIG. 2E illustrates another exemplary touch point pattern 200 in accordance with some embodiments. In FIG. 2E, two touch points are patterned as two concentric shapes, an inner circle (e.g., touch surface 202A) surrounded by a ring (e.g., touch surface 202B). Each of the inner circle touch surface 202A and the ring touch surface 202B provides a touch point for charging, wherein the inner circle touch surface 202A and the ring touch surface 202B provide different phases of voltages (e.g., one is “+” phase and the other is “−” phase). Other touch point/touch surface patterns are contemplated. In some embodiments, the touch surfaces 202A and 202B are located on the earbud 204. In some embodiments, a first charging point 202C and a second charging point 202D are located on a same charging surface/concave surface of 208 a charging case 206. When the earbuds 204 are inserted into the charging case 206, the touch surface 202A (e.g., a circle) is in physical contact with the charging point 202C and the touch surface 202B (e.g., a ring) is in physical contact with the charging point 202D, such that one or more of the earbuds 204 are able to be recharged. Various methods and mechanisms are able to clock/locate the touch surfaces 202A and 202B with the charging points 202C and 202D. For example, the touch surfaces 202A and 202B are able to be coupled/attracted to be coupled with the charging points 202C and 202D using magnets or magnetic forces. Other physical structures are able to be used to locate/clock the touch points of earbuds for charging. In some embodiments, the touch surfaces 202A and 202B are located on the charging case 206 and the charging points 202C and 202D (e.g., for providing an energy source) are on the earbuds 204. Since the touch surfaces 202A and 202B are in circular structures, the charge points 202C and 202D are always in physical/electrical contacts with the touch surfaces 202A and 202B when the earbuds 204 is coupled/inserted into the charging case 206.

FIG. 3 illustrates an exemplary charger 300 in accordance with some embodiments. The charger 300 has at least one receptacle end 302. The charger 300 illustrated in FIG. 3 has two receptacle ends 302. Each receptacle end 302 has a receptacle that is sized to receive an earbud, such as the earbud 100. In some embodiments, the receptacle is adapted/structured to receive at least the front speaker chamber 106 of the earbud 100. The receptacle includes charging pins (not illustrated).

To charge the earbud 100, the tip 108 of the front speaker chamber 106 is inserted into the receptacle. The charging pins (e.g., charging pins 110A and 110B of FIG. 2D) of the receptacle electrically couple with the tip 108 of the front speaker chamber 106 to thereby conductively charge the earbud 100 via the electrical connection with the tip 108 of the front speaker chamber 106. In some embodiments, the charging pins are located on different areas of the receptacle that correspond with different parts of the tip 108 of the front speaker chamber 106. In some embodiments, the number of charging pins corresponds with the number of different parts of the tip 108 of the front speaker chamber 106, although each part of the tip 108 is able to include more than one charging pin. In some embodiments, the charging pins are equally spaced apart.

In some embodiments, when two wireless earbuds 100 are coupled with the charger 300, the two wireless earbuds 100 and the charger 300 together form a pill shape module, which is able to be standalone or integrated with other accessories for carrying, storage, or for other uses.

The ear cushion/cap 112 is able to be left on or removed from the earbud 100 during charging.

In some embodiments, a feature, which is able to be provided by either the earbud 100 (as part of the earbud's electronics) or the charger 300 (as part of the charger's electronics), detects the polarization of the current. Based on the detection, the charging reception is adjusted to fit the correct polarization of the current such that the earbud 100 is able to be coupled with the charger 300 in any direction (e.g., no matter how the A and B parts of the tip 108 of the front speaker chamber 106 are coupled with the charging pins of the charger 300) and be able to charge correctly with the correct polarization of the current.

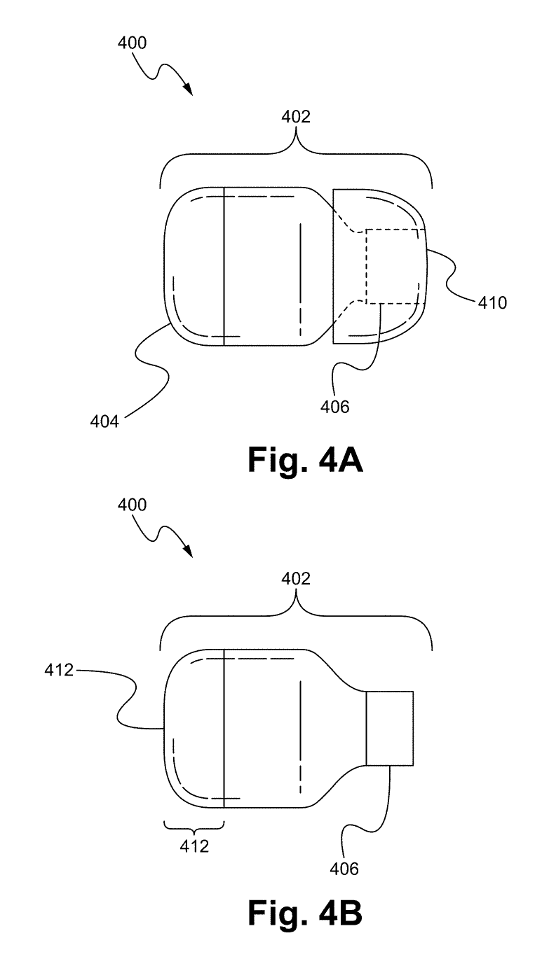

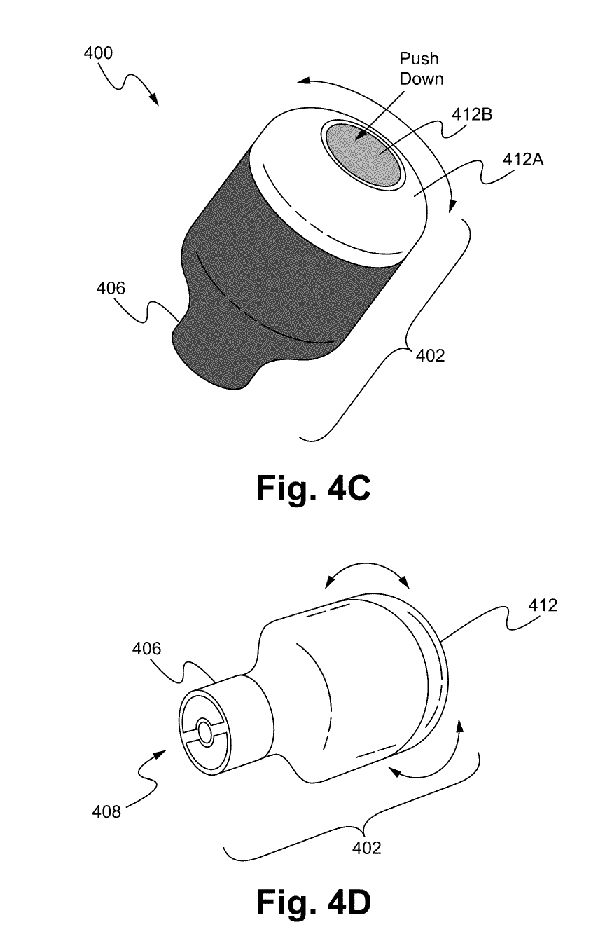

FIGS. 4A-4D illustrates an exemplary earbud 400 in accordance with some embodiments. The earbud 400 has a body 402. The body 402 has an exterior end 404 and a front speaker chamber 406 located at an end opposite the exterior end 404. An ear cushion/cap 410 is sized and shaped to fit over and substantially surround the front speaker chamber 406. In some embodiments, the body 402 is cylindrical with the exterior end 404 being rounded. The earbud 400 has a control interface 412 on the earbud 400. The control interface is located at the exterior end 404, although the control interface is able to be located at a middle part of the body 402.

As illustrated, a tip 408 of the front speaker chamber 406 is narrower than the exterior end 404 (e.g., smaller cross section). In some embodiments, the control interface includes a knob mechanism 412, which is at the exterior end 404 and is designed seamlessly as part of the body 402. The knob mechanism 412 includes a rotating element 412A that is able to be turned left and/or right continuously and a depressing element 412B that is able to be pushed down.

The control interface provides controls for, but not limited to, the following: Volume control to increase and/or decrease volume, Next and previous track control, Accept, reject, and end a call, Play and pause music, Activate voice command, Turn on and off special sound effect, Adjust sound effect and sound equalization, Record voice note, Turn on and off ambient sound effect, and other control functions related to the earbuds.

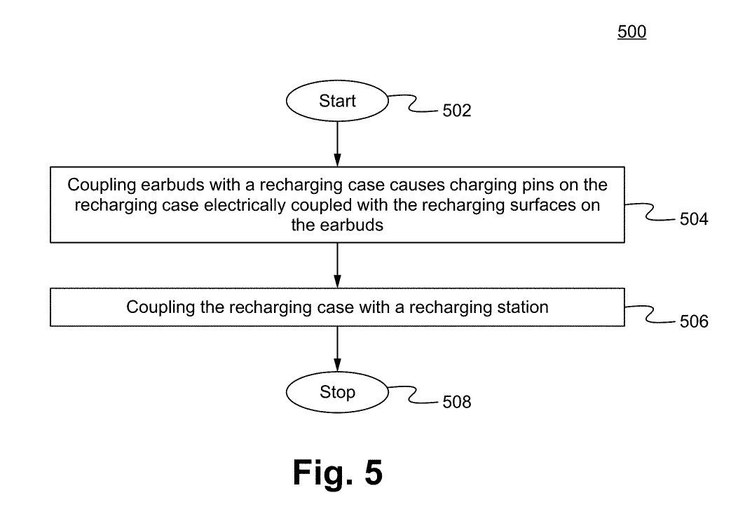

FIG. 5 illustrates a method 500 of recharging wireless earbuds in accordance with some embodiments. The method 500 starts at a Step 502. At a Step 504, earbuds are coupled with a recharging case causing charging pins on the recharging case to electrically couple with the recharging surface on the earbuds. At a Step 506, the recharging case is electrically coupled with a recharging station, so that the recharging station electrically recharges the recharging case. As such, the recharging case serves as a power bank or power carrier for storing an amount of electrical energy that can be greater than the amount of an electrical energy carried by the earbuds. The method 500 ends at a Step 508.

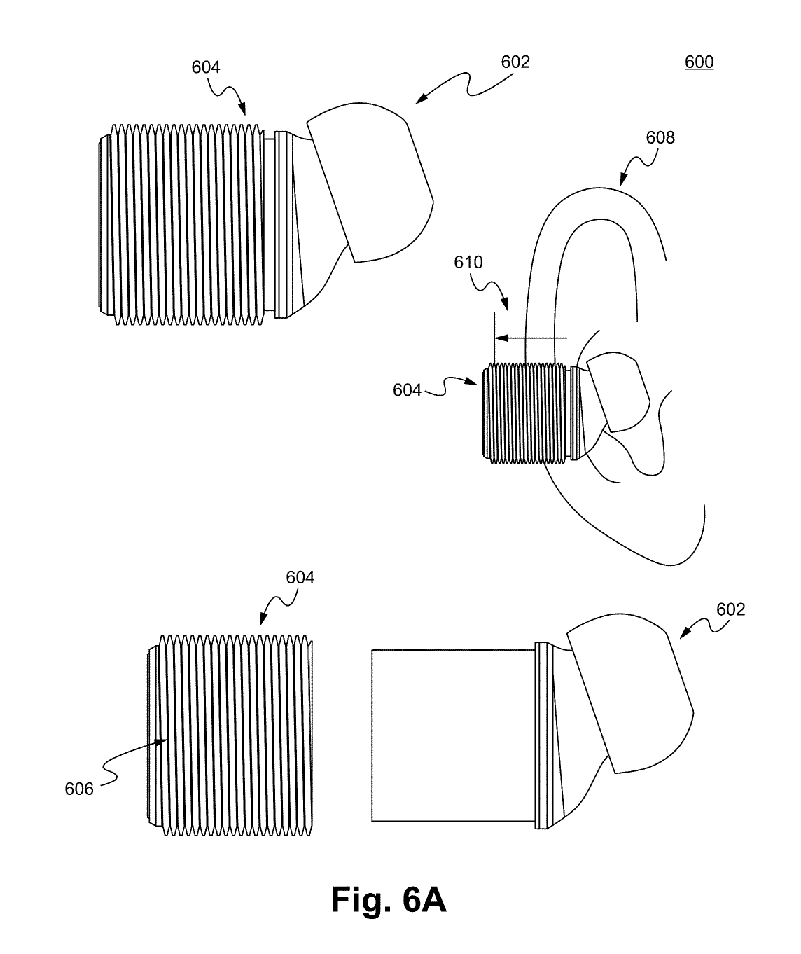

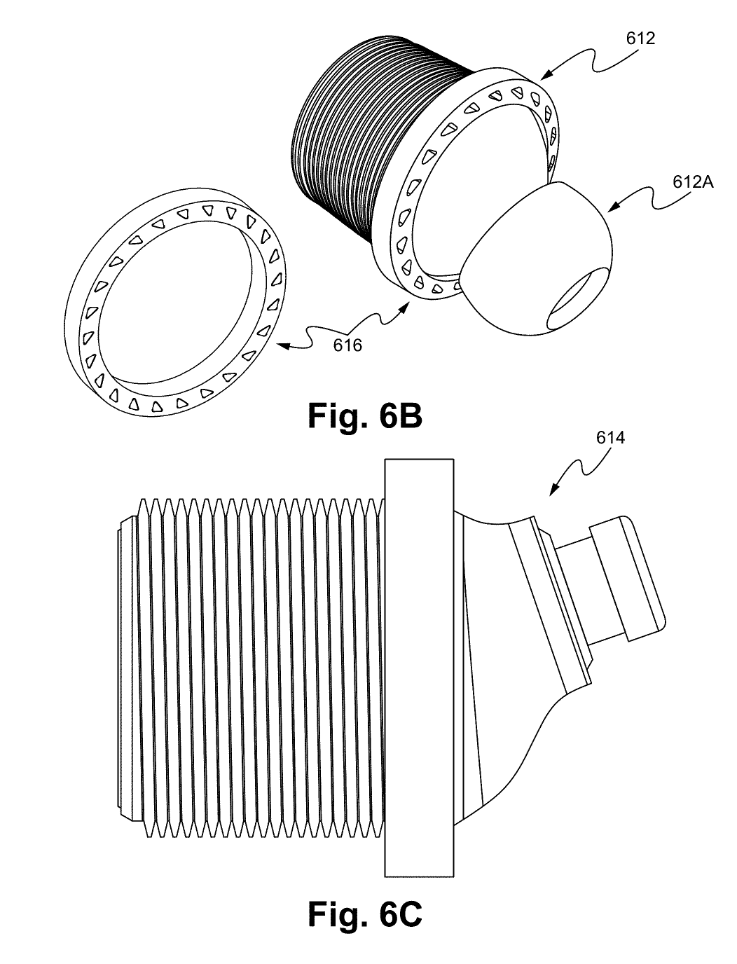

FIGS. 6A-6C illustrate wireless earbuds 600 with retention ring in accordance with some embodiments. In some embodiments, the earbud 600 comprises an earbud piece 602 (e.g., electronic portion for sound generating) coupled with a retention structure 604. In some embodiments, the retention structure 604 comprises a thread structure 606 on the surface of the retention structure 604. In some embodiments, the retention structure 604 comprises a retention ring structure 616, which is able to be separated as a ring component. In some exemplary embodiments, the retention structures 604 are shaped to be a sleeve structure having a cavity to snug-fit and coupled with a body 602 of the earbud 600. The retention structure 604 and 616 are designed to increase the friction (e.g., resistance force 610) or retention ability to prevent the earbud from falling out of the ear 608 of a user. The retention structure is included to enhance the engagement of the earbud with human's ear hole (e.g., ear canal) or skins. FIG. 6B illustrates an earbud 612 with a retention structure with a cap 612A on the speaker portion. FIG. 6C illustrates an earbud 614 with a retention structure without a speaker cap on.

In operation, the earbud is electrically coupled with the charger to conductively charge the earbud by the metal-to-metal coupling between the earbud and the charger. In particular, the metal-to-metal coupling is between the tip of the front speaker chamber of the earbud and the charger. This charging aspect advantageously minimizes the charging interface on the earbud. In comparison to traditional earbuds, the earbud has a lesser chance of being damaged due to the smaller size of its charging interface. The earbud is able to be inserted into the receptacle of the earbud 100 in any direction as the charging reception is automatically adjusted to fit the correct polarization of the current, with or without the ear cushion/cap on the earbud.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims. Features in various examples or embodiments are applicable throughout the Present Specification.

We claim:

1) A wireless earbud comprising:
a) a cylindrical body having a body capable of fitting snugly within in an ear of a user;
b) an exterior end; and
c) a front speaker chamber located at an end opposite the exterior end, wherein the front speaker chamber includes a tip that is substantially planar and comprises one or more charging points.

2) The wireless earbud of claim 1, wherein the one or more charging points comprise a metal surface.

3) The wireless earbud of claim 1, wherein the one or more charging points comprise at least two charging surfaces electrically separated by at least two gaps.

4) The wireless earbud of claim 3, wherein the two charging surfaces with the two gaps form an annulus.

5) The wireless earbud of claim 1, wherein the exterior end comprises a control unit.

6) The wireless earbud of claim 5, wherein the control unit comprises a rotational controlling member.

7) The wireless earbud of claim 6, wherein the control unit comprises a push button.

8) The wireless earbud of claim 7, wherein the push button is surrounded by the rotational controlling member.

9) A method of enabling wireless charging of a wireless earbud, comprising:
a) obtaining a charger, wherein the charger includes at least one receptacle end that includes a receptacle and charging pins;
b) obtaining a wireless earbud that includes an exterior end and a front speaker chamber located at an end opposite the exterior end, wherein the front speaker chamber includes a tip that is substantially planar and a plurality of charging points located at the tip; and
c) inserting the tip of the front speaker chamber of the wireless earbud into the at least one receptacle such that a metal-to-metal coupling between the earbud and the charger is established.

10) The method of claim 9, wherein the charger and two of the wireless earbuds form a pill shape structure.

11) The method of claim 9, wherein the charger is coupled with a power source using two power receiving members on the charger.

12) The method of claim 11, wherein each of the two power receiving members form a circle surrounding the charger.

13) The method of claim 9, wherein the at least one receptacle comprises at least one charging pin.

14) A wireless earbud comprising:
a) a cylindrical body;
b) a control interface located at an external end of the body; and
c) a knob structure at the control interface having a rotating element and a depressing element, wherein the rotating element and the depressing element are able to be activated to control one or more of a plurality of functions.

15) The wireless earbud of claim 14, wherein the depressing element is centered at the rotating element.

16) The wireless earbud of claim 14, wherein the depressing element is configured as a command confirming button.

17) The wireless earbud of claim 14, wherein the rotating element is configured as a command of increasing or reducing volume output of the earbud.

18) The wireless earbud of claim 14, wherein the cylindrical body comprises a charging port at an internal end.

19) The wireless earbud of claim 14, wherein the charging port comprises two charging surfaces.

20) The wireless earbud of claim 14, wherein the two charging surfaces are electrically isolated by one or more gaps.

21) A wireless earbud concentric recharging device comprising:
a) a wireless earbud containing a first charging terminal and a second charging terminal, wherein the second charging terminal forms a concentric ring surrounding the first charging terminal; and
b) a power supplying source containing a first power supplying terminal and a second power supply terminal, wherein the first power supplying terminal is structured to couple with the first charging terminal and the second power supplying terminal is structured to couple with the second charging terminal when the wireless earbud is coupled with the power supplying source.

22) The device of claim 21, further comprises a gap material electrically isolate the first charging terminal from the second charging terminal.

23) The device of claim 22, wherein the gap material form a concentric ring surrounding the first charging terminal.

24) The device of claim 21, wherein the wireless earbud contains a magnet configured to facilitate the coupling of the earbud with the power supplying source.

25) The device of claim 21, wherein the wireless earbud has a structure configured to couple the first charging terminal with the first power supplying terminal and the second charging terminal with the second power supplying terminal when the wireless earbud is coupled with a house of the power supplying source.

26) The device of claim 21, wherein power supplying source comprises a charging case.
